(19) United States
(12) Patent Application Publication
(10) Pub. No.: US 2010/0209173 A1
(43) Pub. Date: Aug. 19, 2010

(54) LEAD CARTRIDGE AND MECHANICAL PENCIL WITH BUILT-IN LEAD CARTRIDGE

(76) Inventors: Hidehei Kageyama, Saitama (JP); Yoshio Noguchi, Saitama (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/733,834

(22) PCT Filed: Sep. 22, 2008
(86) PCT No.: PCT/JP2008/067088

§ 371 Date: Mar. 23, 2010

(30) Foreign Application Priority Data
Sep. 25, 2007 (JP) 2007-247894
Nov. 15, 2007 (JP) 2007-296599

(51) Int. Cl. B43K 21/14; B43K 21/00

(52) U.S. Cl. 401/57; 401/85

(57) ABSTRACT

A lead cartridge that is provided with a tank part for storing leads and is capable of being detachably connected to a receiving part provided in a lead feeding mechanism of a mechanical pencil to supply a lead can reduce costs for manufacturing the lead cartridge and the number of manufacturing steps and can prevent a lead from falling out from the lead cartridge inadvertently.

The lead cartridge 10 includes a case 12 and a swing cover 14. A tank part 12a is defined inside the case 12 and the tip end part of the case 12 is formed with an open tip end connection part 12b. Between the tank part 12a and the tip end connection part 12b, a lead port 12e is formed. The swing cover 14 is mounted in the case 12 swingably to a closing position where the swing cover 14 closes the lead port 12e and to an opening position where the swing cover 14 opens the lead port 12e. The swing cover 14 includes an interfered part 14c capable of being interfered with an interference part 46e of a cartridge receiving part 46b of the mechanical pencil. The swing cover 14 is biased in a swing direction from the opening position to the closing position but swings from the closing position to the opening position when the tip end connection part 12b is fitted with the cartridge receiving part 46b so as to cause the interfered part 14c to be interfered with the interference part 46e.

### TECHNICAL FIELD

The invention relates to a lead cartridge for refilling a mechanical pencil with leads or for changing leads of a mechanical pencil, and to a mechanical pencil with built-in the lead cartridge.

### BACKGROUND ART

As a lead cartridge of this type, a lead cartridge disclosed in Patent Document 1 (Japanese Patent Application examined Publication No. 6-2438) is conventionally known. According to the document, the lead cartridge includes a tip end opening to be detachably inserted into a lead guide, which is provided in a lead feeding mechanism of the mechanical pencil. In the tip end opening, a chuck opening/closing is mounted. The chuck opening/closing mechanism is provided with a lead port, which is opened when the tip end opening is inserted to and engaged with the lead guide and closed when the tip end opening is not engaged.

The chuck opening/closing mechanism includes a pair of elastic opening/closing sections and outwardly engagement sections, which are formed integrally with the elastic opening/closing sections on the tip end side thereof to protrude outwardly in a diameter direction to opposite side to each other and each of which has a tip formed in a round shape. The elastic opening/closing sections form the lead port at the axis center on the tip end side and are elastically deformed to opposite directions to close the lead port by an inward elastic force. When the outwardly engagement sections are press-inserted to and engaged with the lead guide, the outwardly engagement sections move inwardly in a diameter direction against the inward elastic force to open the lead port. When the outwardly engagement sections are pulled out from the lead guide so as to be released from the press-inserted engagement, the outwardly engagement sections move outwardly in the diameter direction by an elastic restoring force to close the lead port.

### SUMMARY OF INVENTION

### Technical Problem

However, since the configuration disclosed in Patent Document 1 includes the opening/closing mechanism of chuck type, it requires at least two parts. Accordingly, more costs for manufacturing and troublesome mounting work of the parts of the opening/closing mechanism are unfortunately required. Therefore, further improvement has been demanded.

In addition, since the outwardly engagement sections formed in a round shape protrude outwardly, the lead port is accidentally opened if the outwardly engagement sections are pushed inwardly under a condition that the lead port should be closed, resulting in inadvertent falling out of the lead from the lead cartridge.

Further, since the pair of elastic opening/closing sections is mounted at the tip end opening, the problem is that the lead cartridge has to be longer corresponding to the pair of elastic opening/closing sections.

The invention has been accomplished in view of the above defects and the object thereof is to provide a lead cartridge capable of reducing costs for manufacturing and the number of manufacturing steps and capable of preventing leads from falling out from the lead cartridge inadvertently.

In addition, another object of the invention is to provide a lead cartridge allowing the lead cartridge to be connected to a mechanical pencil even with a lead held by a lead feeding mechanism in the mechanical pencil.

### Solution to Problem

To accomplish the above objects, a lead cartridge according to an aspect of the invention, which is provided with a tank part for storing leads and is capable of being detachably connected to a receiving part provided in a lead feeding mechanism of a mechanical pencil to supply a lead, includes:

a tip end connection part that can be detachably fitted with the receiving part;

a lead port provided on a tip end side of the tank part to allow a lead to pass therethrough from the tank part;

and a swing cover that is arranged in the lead cartridge swingably between a closing position where the swing cover closes the lead port and an opening position where the swing cover opens the lead port and that includes an interfered part capable of being interfered with an interference part provided in the mechanical pencil, wherein

the swing cover is biased in a swing direction from the opening position to the closing position but swings from the closing position to the opening position when the tip end connection part is fitted with the receiving part so as to cause the interfered part to be interfered with the interference part.

Since the lead port can be closed/opened by the swing cover according to the aspect of the invention, the number of the parts is reduced, and thus the number of steps for mounting the swing cover is reduced. Therefore, costs for manufacturing and the number of manufacturing steps can be reduced.

In addition, the swing cover closes the lead port in the lead cartridge and it is difficult to easily operate the swing cover from the outside. Therefore, the swing cover may not be inadvertently operated and leads can be prevented from falling out from the tank part.

Since the swing cover swings in the lead cartridge, the whole length of the lead cartridge can be shortened.

The lead cartridge may further include a case, wherein the tank part is formed inside the case, the tip end connection part is formed at a tip end part of the case, the lead port is formed between the tank part and the tip end connection part in the case, and the swing cover can be mounted in a side opening formed in a side part of the case. Since only the swing cover is needed to be mounted in the case, the number of parts is reduced, and thus the number of steps for mounting the swing cover is reduced. Therefore, costs for manufacturing and the number of manufacturing steps can be reduced.

The interfered part may be formed with a tapering surface formed at a tip end of the swing cover. With the tapering surface of the interfered part, the swing cover can smoothly swing.

At least a part of the swing cover may be arranged in the tank part. Because at least a part of the swing cover is arranged in the tank part, a space for the swing cover can be efficiently secured in the tank part, and thus the length of the lead cartridge can be shortened.

A protrusion that closes the lead port may be formed on the swing cover and a protruding end of the protrusion may be in a tapering shape. Since the protruding end of the protrusion is in a tapering shape, even when at least a part of the swing cover is arranged in the tank part, its volume occupying in the tank part can be small. Therefore, a lead storage volume of the tank part can be secured.

The lead cartridge may further include a stick article advancing mechanism that advances a stick article through a rotating operation at a rear part of the lead cartridge. A stick article such as an eraser can have a sufficient length in an axial direction, and thus stick articles can be changed at the same time as replacement or replenishment of leads.

The swing cover may be swingable by a lead held by the lead feeding mechanism in the mechanical pencil. Even when a lead held by the lead feeding mechanism remains in the mechanical pencil, the lead can cause the swing cover to swing and can enter the lead cartridge through the lead port.

In a mechanical pencil into which the lead cartridge according to the aspect of the invention is to be loaded, the interference part may be formed with a tapering surface capable of interfering with the tip end of the swing cover. With the tapering surface of the interference part, the swing cover can smoothly swing.

Further, a lead cartridge according to another aspect of the invention, which is provided with a tank part for storing leads and is capable of being detachably connected to a receiving part provided in a lead feeding mechanism of a mechanical pencil to supply a lead, includes:

a tip end connection part that can be detachably fitted with the receiving part;

a lead port provided on a tip end side of the tank part to allow a lead to pass therethrough from the tank part;

and a swing cover that is arranged swingably to a closing position where the swing cover closes the lead port and to an opening position where the swing cover opens the lead port at a position posterior to the lead port, wherein

the swing cover is biased in a swing direction from the opening position to the closing position, and prevents a lead in the tank part from aligning with the lead port in a condition closing the lead port.

Since the swing cover prevents a lead in the tank part from aligning with the lead port in a condition closing the lead port, even if a lead held by the lead feeding mechanism remains in the mechanical pencil when the lead cartridge is inserted into the mechanical pencil, the swing cover prevents this lead from aligning with a lead in the tank part while this lead is passing through the lead port and making the swing cover swing. Therefore, the leads can be prevented from interfering with each other so as to be broken.

### BRIEF DESCRIPTION OF THE DRAWINGS

FIG. 1 is a whole longitudinal sectional view showing a lead cartridge according to the invention.

FIG. 2(a) is a plan view of a case of the lead cartridge of FIG. 1.

FIG. 2(b) is a longitudinal sectional view of the case of the lead cartridge of FIG. 1.

FIG. 2(c) is a sectional view taken along line 2c-2c of FIG. 2(b).

FIG. 2(d) is a sectional view taken along line 2d-2d of FIG. 2(b).

FIG. 2(e) is a sectional view taken along line 2e-2e of FIG. 2(b).

FIG. 3(a) is a side view of a swing cover of the lead cartridge of FIG. 1.

FIG. 3(b) is a perspective view of the swing cover of the lead cartridge of FIG. 1.

FIG. 4 is a longitudinal sectional view of an eraser advancing mechanism of the lead cartridge of FIG. 1.

FIG. 5 is a longitudinal sectional view of the lead cartridge of FIG. 1 in a state loaded in a mechanical pencil.

FIG. 6 is an enlarged sectional view of a chuck joint.

FIG. 7 is a view showing a relationship between the lead cartridge and a receiving part when the lead cartridge is being connected to the mechanical pencil.

FIG. 8 is a whole longitudinal sectional view of a lead cartridge according to another embodiment of the invention.

FIG. 9 is a longitudinal sectional view of a case of the lead cartridge of FIG. 8.

FIG. 10 is a view showing a relationship between the lead cartridge and a mechanical pencil when a lead held by a lead feeding mechanism remains in the mechanical pencil.

### REFERENCE SIGNS LIST

10 lead cartridge
12, 12′ case
12a tank part
12b tip end connection part
12e lead port
12g side opening
14 swing cover
14c interfered part
14e protrusion
16, 16′ eraser advancing mechanism (stick article advancing mechanism)
30 mechanical pencil
34 lead feeding mechanism
46b cartridge receiving part
46e interference part

### DESCRIPTION OF EMBODIMENTS

An embodiment of the invention will be described hereinafter with reference to the drawings.

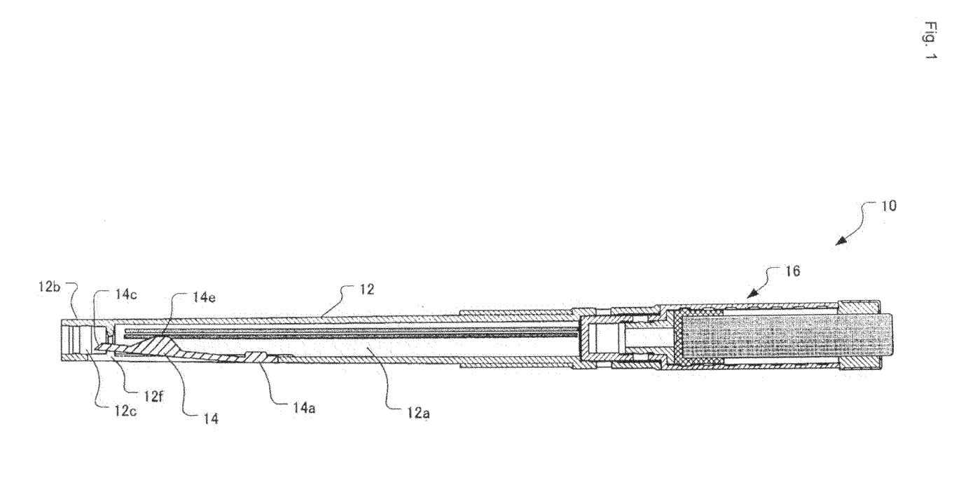

FIG. 1 is a whole longitudinal sectional view showing a lead cartridge according to the invention.

As shown in FIG. 1, a lead cartridge 10 includes a case 12, a swing cover 14, and an eraser advancing mechanism 16.

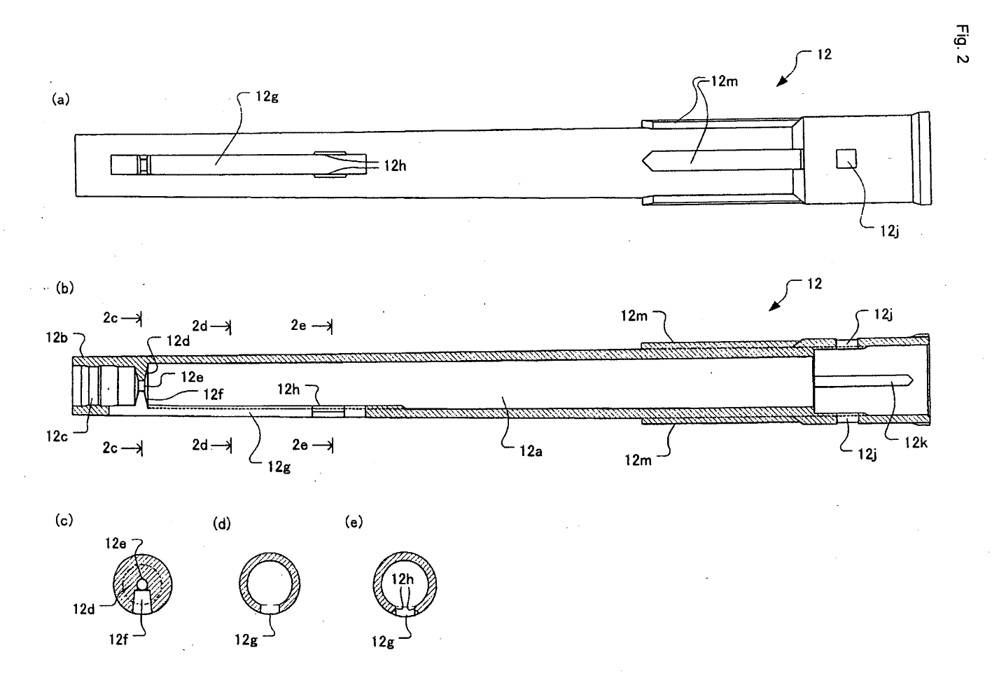

The case 12 may be configured as an integrated plastic molding and has an entirely cylindrical form as shown in enlarged scale in FIG. 2. A tank part 12a that stores leads is defined inside the case 12. The tip end part of the case 12 is formed with an open tip end connection part 12b. The tip end connection part 12b can be detachably fitted to a receiving part provided at a lead feeding mechanism of a mechanical pencil to be described below. To this end, a fitting rib 12c for engaging with the receiving part is formed on the inner surface of the tip end connection part 12b.

A partition wall 12d is formed between the tank part 12a and the tip end connection part 12b inside the case 12, and a lead port 12e having a form corresponding to a shape of a lead is formed at the center of the partition wall 12d so as to allow leads to pass therethrough one by one. The partition wall 12d is funnel-shaped toward the lead port 12e. In addition, the partition wall 12d is formed with a notch 12f extending in a diameter direction to reach the lead port 12e.

In a side surface of the case 12, a side opening 12g extending in an axial direction across the tank part 12a, the tip end connection part 12b, and the partition wall 12d is formed. The side opening 12g communicates with the notch 12f. A part having an extended opening width is formed at the rear end part of the side opening 12g, and at the part, engagement protrusions 12h that protrude toward the center of the opening from either opening side walls are formed as shown in FIG. 2(e).

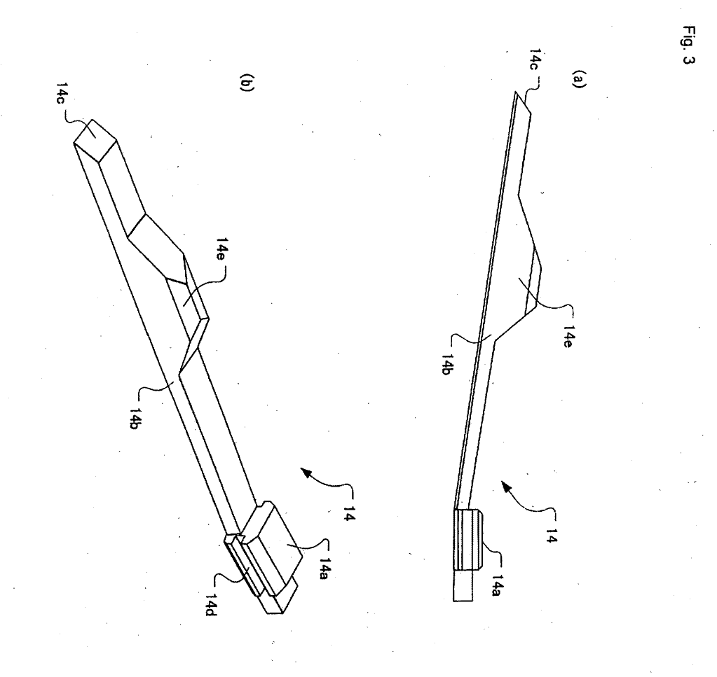

The swing cover 14 that can be configured as an integrated plastic molding includes a base 14a, a swing body 14b, and an interfered part 14c as shown in enlarged scale in FIG. 3.

In side surfaces of the base 14a, engagement grooves 14d that engage with the engagement protrusions 12h in the side opening 12g of the case 12 are formed. When the engagement grooves 14d engage with the engagement protrusions 12h, the base 14a can be mounted at the rear end part of the side opening 12g.

The swing body 14b is bent from the base 14a and biased into a bent state due to its own elasticity in a normal condition. However, the swing body 14b can be deformed to align with the base 14a against the elasticity. In the middle of the swing body 14b in an axial direction, a protrusion 14e is formed. The protrusion 14e has a protruding end in a tapering shape and is formed with a tapering surface inclined toward the tip end part as shown in FIG. 3(b).

The interfered part 14c is formed at the tip end of the swing body 14b and more specifically, is formed as a tapering surface that is thinner toward the tip end part of the swing body 14b.

At the rear end part of the case 12, the eraser advancing mechanism 16 is mounted as a stick article advancing mechanism. Instead of the eraser advancing mechanism 16, a simple stopper or a fixed eraser holder that is not advanced may be mounted at the rear end part of the case 12. However, if the eraser advancing mechanism 16 is mounted, erasers can be changed at the same time as refilling or changing leads. Further, if the eraser advancing mechanism 16 is mounted, an eraser can have a sufficient length in an axial direction, and thus the eraser can last a long time until finishing up leads in the lead cartridge 10.

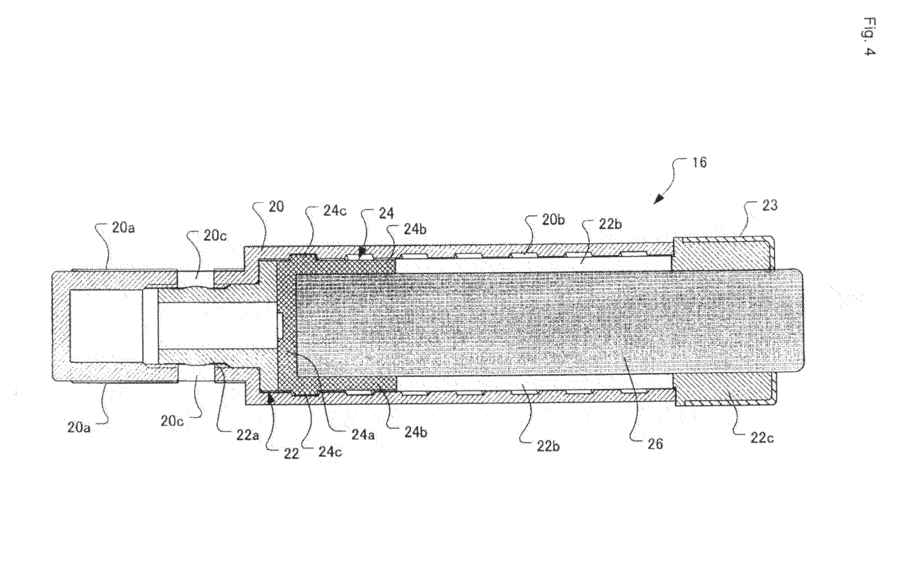

Although the eraser advancing mechanism 16 can have an arbitrary configuration, the eraser advancing mechanism 16 in this embodiment includes a spiral sleeve 20, a guide sleeve 22, and an eraser holder 24 for holding an eraser 26 as shown in FIG. 4.

The spiral sleeve 20 is provided with engagement projections 20a that engage with a pair of engagement holes 12j formed in a rear part of the case 12. The engagement projections 20a engage with the engagement holes 12j and a rib 12k (see FIG. 2(b)) formed on the inner surface of the rear end part of the case 12 engages with a longitudinal groove (not shown) formed in the outer surface of the spiral sleeve 20, whereby the spiral sleeve 20 is connected to the case 12 non-rotatably with respect to the case 12 and immovably in an axial direction. A spiral groove 20b is formed in the inner surface of the spiral sleeve 20 and engagement holes 20c are formed in the outer surface thereof at a position anterior to a part where the spiral groove 20b is formed.

The guide sleeve 22 is inserted into the spiral sleeve 20 from the rear side thereof. At the tip end of the guide sleeve 22, an engagement sleeve 22a that engages with the engagement holes 20c is formed; in the middle of the guide sleeve 22, a pair of guide slits 22b extending in an axial direction is formed; and at the rear end part of the guide sleeve 22, an operating part 22c having an extended diameter is formed. Here, a decorative ring 23 may be appropriately mounted on the operating part 22c. The engagement sleeve 22a is formed to engage with the engagement holes 20c of the spiral sleeve 20 in a rotatable manner when the guide sleeve 22 is inserted into the spiral sleeve 20 from the rear side thereof.

When the operating part 22c and the engagement sleeve 22a of the guide sleeve 22 respectively engage with the spiral sleeve 20 in front and rear thereof, the guide sleeve 22 is arranged immovably in an axial direction and rotatably with respect to the spiral sleeve 20 on the inner surface side of the spiral sleeve 20.

The eraser holder 24 is arranged slidably in an axial direction with respect to the guide sleeve 22 and rotatably with respect to the spiral sleeve 20 in the guide sleeve 22. The eraser holder 24 includes a bottom part 24a for receiving a bottom face of the eraser 26 and a pair of holding sections 24b extending rearward from the bottom part 24a to hold the eraser 26. The holding sections 24b are fitted in the guide slits 22b of the guide sleeve 22 to be slidable in an axial direction in the guide slits 22b. An external thread 24c is formed on the outer surface of the holding sections 24b to be threaded with the spiral groove 20b of the spiral sleeve 20.

In the lead cartridge 10 configured as described above, the swing body 14b of the swing cover 14 bends from the base 14a toward the inside of the lead cartridge 10 when the lead cartridge 10 is stored alone by itself as shown in FIG. 1. Accordingly, the swing body 14 is positioned at the innermost of the notch 12f in a diameter direction to be in a closing position where specifically the protrusion 14e of the swing cover 14 closes the lead port 12e. Therefore, leads in the tank part 12a are prevented from passing through the lead port 12e.

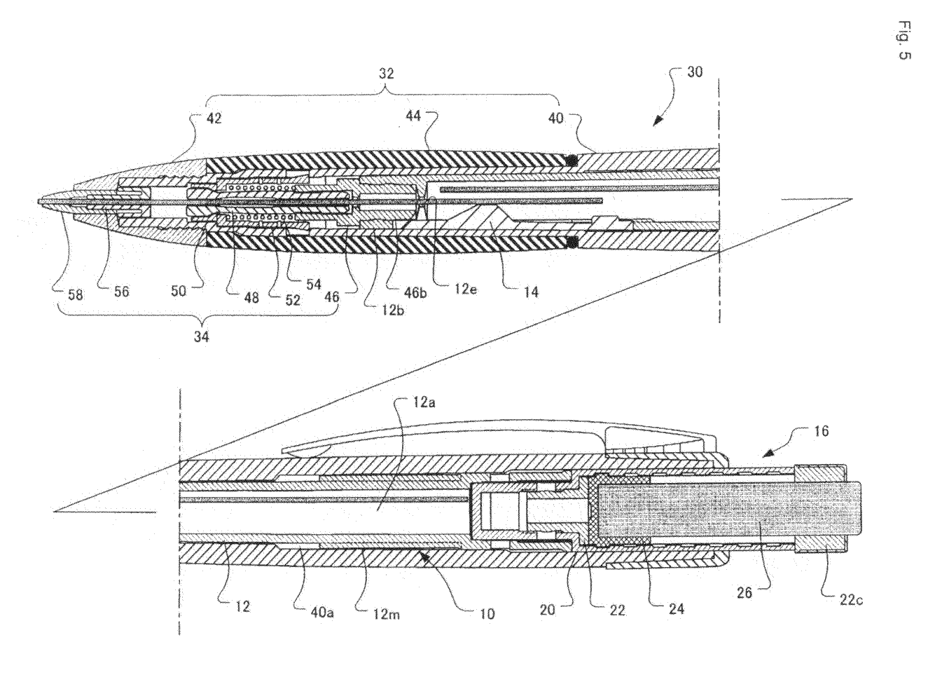

FIG. 5 shows the lead cartridge 10 configured as described above in a state incorporated in a mechanical pencil 30. The mechanical pencil 30 includes an outer sleeve 32 and a lead feeding mechanism 34 mounted inside the outer sleeve 32.

The outer sleeve 32 includes a main body 40, a tip tool 42 to be threaded with the tip end of the main body 40, and a grip body 44 mounted on a grip part of the main body 40. On the inner surface of the main body 40, a rotation stop groove 40a is formed. When a rotation stop rib 12m of the case 12 of the lead cartridge 10 is engaged with the rotation stop groove 40a, the case 12 and the outer sleeve 32 are prevented from rotating with respect to each other.

The lead feeding mechanism 34 includes: a chuck joint 46; a lead chuck 48, the rear end of which is press-inserted into the chuck joint 46 to tighten a lead, and feed the lead; a chuck ring 50 fitted to the outer surface of the chuck part of the lead chuck 48 so as to be capable of tightening the chuck part; a sleeve 52 that limits a rearward movement of the chuck ring 50 and is engaged with the main body 40; a chuck spring 54 arranged between the sleeve 52 and the chuck joint 46 to bias the chuck joint 46 and the lead chuck 48 rearward; a slider 56 that is movable in the tip tool 42 and the tip end part of the main body 40; and a lead pipe 58, the rear end of which is connected to the slider 56.

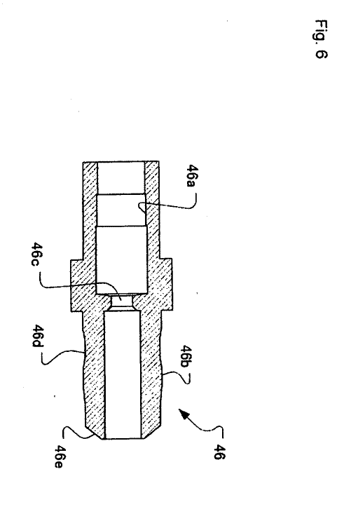

As shown in enlarged scale in FIG. 6, the chuck joint 46 includes a chuck press-insertion hole 46a, into which the rear end of the lead chuck 48 is press-inserted; a cartridge receiving part 46b, to which the tip end connection part 12b of the case 12 of the lead cartridge 10 is detachably connected; and a lead feeding hole 46c, through which leads pass one by one. On the outer surface of the cartridge receiving part 46b, a fitting recess part 46d that fits with the fitting rib 12c of the tip end connection part 12b of the case 12 is formed. The rear end surface of the cartridge receiving part 46b is formed as an interference part 46e. The interference part 46e is not perpendicular to an axial direction but has inclined tapering surfaces.

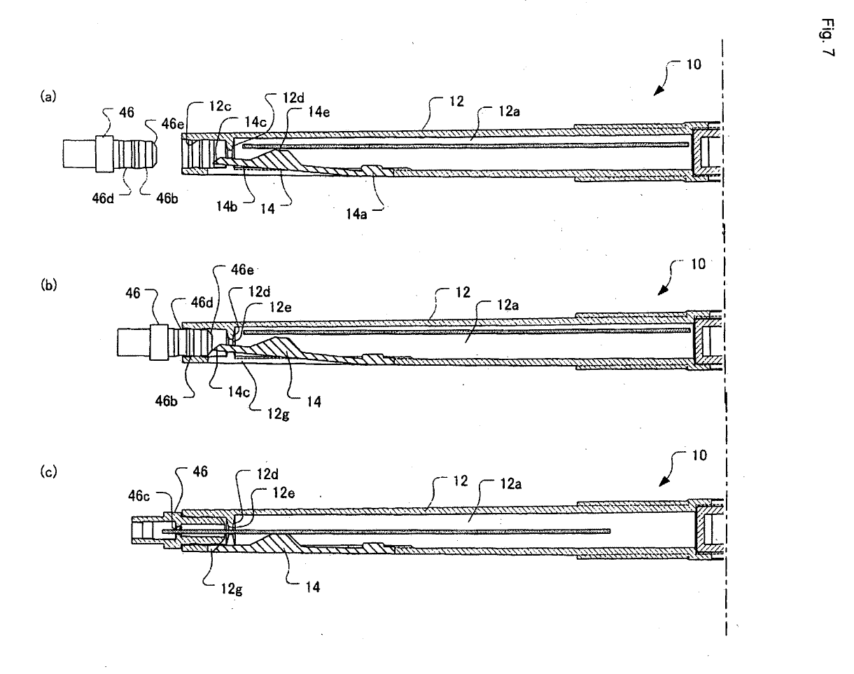

A connection between the lead cartridge 10 and the mechanical pencil 30 configured as described above is explained referring to FIG. 7.

The lead cartridge 10 is inserted to the mechanical pencil 30 from the rear side of the main body 40. When the tip end connection part 12b of the case 12 of the lead cartridge 10 reaches the cartridge receiving part 46b of the chuck joint 46, the cartridge receiving part 46b is inserted into the tip end connection part 12b.

At the same time, the tapering surface of the interfered part 14c at the tip end of the swing cover 14 slidably contacts with the tapering surface of the interference part 46e of the chuck joint 46, and the swing cover 14 swings when the cartridge receiving part 46b is inserted (FIG. 7(b)). When the cartridge receiving part 46b is entirely inserted into the tip end connection part 12b to fit the fitting rib 12c with the fitting recess part 46d, the swing cover 14 is deformed from the bent to align with the side hole 12g as shown in FIG. 7(c) so as to move to an opening position where the swing cover 14 opens the lead port 12e. Then the lead port 12e aligns with the lead feeding hole 46c. A lead can slide along the partition wall 12d in a funnel-shape from the tank part 12a, pass through the lead port 12e and the lead feeding hole 46c, and advance to the lead chuck 48. In this manner, it is possible to refill or change leads easily.

On the other hand, the lead cartridge 10 can be easily detached by pulling out the lead cartridge 10 from the outer sleeve 32. When the tip end connection part 12b of the lead cartridge 10 is separated away form the cartridge receiving part 46b, the swing cover 14 swings back by its elastic restoring force to move to the closing position where the swing cover 14 closes the lead port 12e. Therefore, even when some leads remain in the tank part 12a, the leads can be prevented from falling out from the lead cartridge 10.

When the lead cartridge 10 is incorporated in the mechanical pencil 30 as described above, the rear end part of the lead cartridge 10 including the operating part 22c of the guide sleeve 22 of the eraser advancing mechanism 16 protrudes out from the rear end of the outer sleeve 32. When the rear end part of the lead cartridge 10 is knocked forwardly, the chuck joint 46, lead chuck 48, and chuck ring 50 advance together with the lead cartridge 10 so as to send out a lead in a previously known manner to allow writing.

In addition, in order to use the eraser, the operating part 22c of the rear end part is operated to rotate while the outer sleeve 32 is fixed. Since the outer sleeve 32, case 12, and spiral sleeve 20 are prevented from rotating with respect to each other, the eraser holder 24 rotating integrally with the guide sleeve 22 rotates with respect to the case 12. Then the external thread 24c of the eraser holder 24 moves along the spiral groove 20b so as to advance the eraser 26. Further, when the operating part 22c is rotated in an opposite direction, the eraser 26 is retracted back into the spiral sleeve 20.

Since the opening/closing mechanism of the lead cartridge 10 is configured as the swing cover 14 as described above, the number of parts is reduced, and thus the number of steps for mounting the swing cover 14 to the case 12 can be reduced. Therefore, costs for manufacturing and the number of manufacturing steps can be reduced.

In addition, when the lead cartridge 10 exists by itself, the swing cover 14 closes the lead port 12e inside the lead cartridge 10 and it is difficult to easily operate the swing cover 14 from the outside. Therefore, the swing cover 14 may not be inadvertently operated so that leads are prevented from falling out from the tank part.

Further, since the swing cover 14 is arranged inside the lead cartridge 10, the whole length of the lead cartridge 10 can be short. Although the swing cover 14 has the protrusion 14e positioned inside the tank part 12a to close the lead port 12e, the protrusion 14e is in a tapering shape so as to make its volume occupying in the tank part 12a small. Therefore, a lead storage volume of the tank part 12a can be secured.

Here, an engagement force between engagement holes 12j of the case 12 and the engagement projection 20a of the spiral sleeve 20, the engagement force serving as a connecting force between the case 12 and the eraser advancing mechanism 16, needs to be larger than a connecting force between the lead cartridge 10 and the mechanical pencil 30 but is preferably small enough to allow a person to release the connection by hand. With such a configuration, it is possible to remove the eraser advancing mechanism 16 from the case 12 when the lead cartridge 10 exists by itself to allow for refilling with leads from the rear end of the case 12. For this purpose, it is preferable to provide short tapering parts on both side surfaces of the engagement projection 20a and/or the engagement holes 12j so as to allow for releasing the connection. Alternatively, it is possible to set a connection direction between the case 12 and the eraser advancing mechanism 16 and a connection direction between the lead cartridge 10 and the mechanical pencil 30 to be different instead of adjusting magnitude of the connecting force. For example, when the connection between the lead cartridge 10 and the mechanical pencil 30 is made/released by pushing/pulling in an axial direction, the connection between the case 12 and the eraser advancing mechanism 16 may be made/released through a rotating operation in clockwise/counterclockwise direction or in opposite directions.

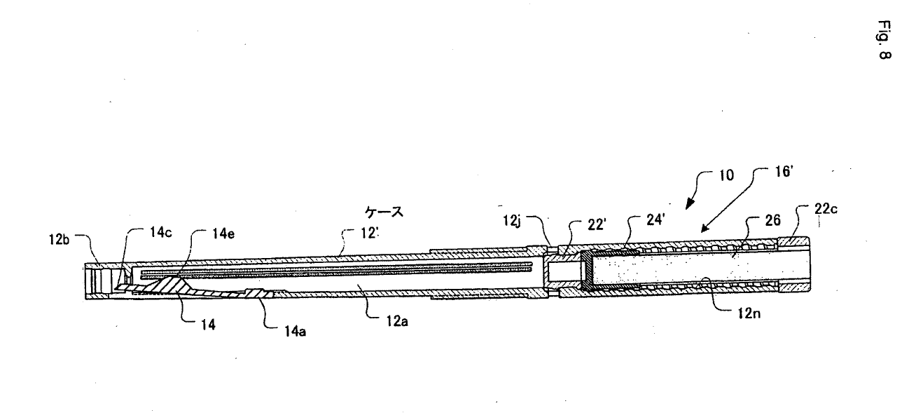

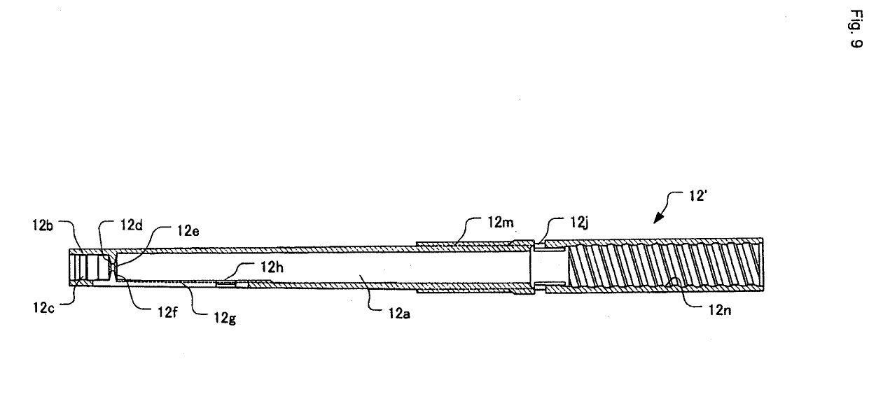

FIG. 8 is a longitudinal sectional view showing another embodiment of the lead cartridge 10. In this embodiment, a case 12′ is a part of an eraser advancing mechanism 16′ and the spiral sleeve is omitted. Specifically, the rear part of the case 12′ is arranged to extend more rearwardly than the tank part 12a as shown in FIG. 9 and a spiral groove 12n is formed in the inner surface of the rear part. A guide sleeve 22′ is rotatably engaged with the engagement holes 12j and the guide sleeve 22′ is connected to the case 12′ so as to be rotatable with respect to the case 12′ and immovable in an axial direction. An eraser holder 24′ is arranged in the guide sleeve 22′ so as to be slidable in an axial direction with respect to the guide sleeve 22′ and rotatable with respect to the case 12′, and an external thread of the eraser holder 24′ is threaded with the spiral groove 12n of the case 12′.

The eraser 26 can be advanced or retracted back into the case 12′ through a rotating operation of the operating part 22c at the rear end part of the guide sleeve 22′ that protrudes from the case 12′. With such configuration, the number of parts of the lead cartridge 10 can be reduced.

Although the interference part 46e is formed in the cartridge receiving part 46b in the embodiment described above, the configuration of the interference part 46e is not limited thereto and the interference part 46e may be formed in an arbitrary part of the mechanical pencil 30 other than the cartridge receiving part 46b as long as the part can contact with the interfered part 14c.

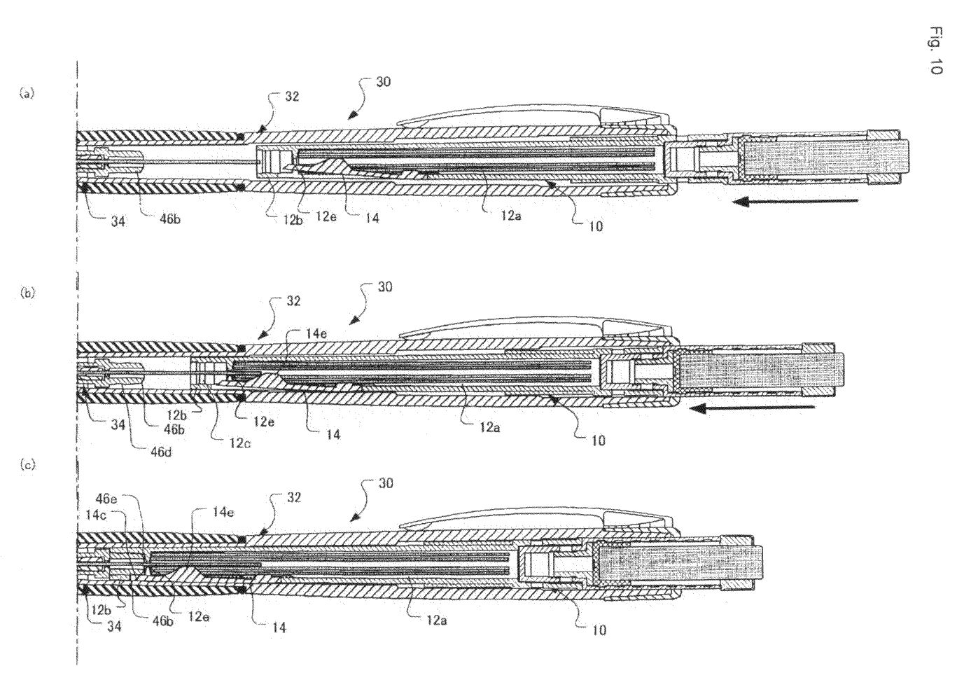

The lead cartridge 10 of the invention can be inserted into the mechanical pencil 30 even when a lead held by the lead feeding mechanism 34 remains in the mechanical pencil 30. The lead held by the lead feeding mechanism 34 in the mechanical pencil 30 can make the swing cover 14 swing and the lead port 12e provides an opening allowing the lead to be inserted therethrough. FIG. 10 is a view showing the mechanical pencil 30 when the lead cartridge is inserted with a lead remaining in the mechanical pencil 30.

When the lead cartridge 10 reaches the rear end of the lead remaining in the mechanical pencil 30 (FIG. 10(a)), the rear end of the lead passes through the lead port 12e and contacts the protrusion 14e so as to make the swing cover 14 swing (FIG. 10(b)). Then the lead can advance into the tank part 12a of the lead cartridge. At this time, since leads that are originally stored in the tank part 12a of the lead cartridge 10 have been arranged around the swing cover 14, the leads do not interfere with the lead being inserted, and thus the leads can be prevented from being broken.

After that, when the tip end connection part 12b of the case 12 of the lead cartridge 10 reaches the cartridge receiving part 46b of the chuck joint 46, the cartridge receiving part 46b is inserted into the tip end connection part 12b, so that the fitting rib 12c is fitted with the fitting recess part 46d (FIG. 10(c)). When the tapering surface of the interfered part 14c at the tip end of the swing cover 14 slidably concats with the tapering surface of the interference part 46e of the chuck joint 46, the swing cover 14 completely opens the lead port.

Since the swing cover 14 of the lead cartridge 10 swings even when a lead remains in the mechanical pencil 30 as described above, it is possible to finish up the lead and to continuously use a lead supplied from the cartridge 10.

Since the swing cover 14 substantially closes the lead port 12e at a position posterior to the lead port 12e but does not directly choke the lead port 12e, a lead remaining in the mechanical pencil 30 can pass through the lead port 12e. In addition, because of the existence of, protrusion 14e of the swing cover 14, no lead is present at the rear of the protrusion 14e, so that no lead aligns with the lead port 12e. Therefore, a lead remaining in the mechanical pencil 30 and a lead stored in the tank part 12a of the lead cartridge 10 can be prevented from aligning with each other. If they aligned with each other, a lead in the tank part 12a would be pushed rearwardly so as to hit the eraser advancing mechanism 16 provided at the rear end of the tank part 12a, then the lead might be broken. Such situation can be prevented in this embodiment.

1. A lead cartridge that is provided with a tank part for storing leads and is capable of being detachably connected to a receiving part provided in a lead feeding mechanism of a mechanical pencil to supply a lead, the lead cartridge comprising:
a tip end connection part that can be detachably fitted with the receiving part;
a lead port provided on a tip end side of the tank part to allow a lead to pass therethrough from the tank part; and
a swing cover that is arranged in the lead cartridge swingably between a closing position where the swing cover closes the lead port and an opening position where the swing cover opens the lead port and that includes an interfered part capable of being interfered with an interference part provided in the mechanical pencil, wherein
the swing cover is biased in a swing direction from the opening position to the closing position but swings from the closing position to the opening position when the tip end connection part is fitted with the receiving part so as to cause the interfered part to be interfered with the interference part.

2. The lead cartridge according to claim 1, further comprising a case, wherein
the tank part is formed inside the case, the tip end connection part is formed at a tip end part of the case, the lead port is formed between the tank part and the tip end connection part in the case, and the swing cover is mounted in a side opening formed in a side part of the case.

3. The lead cartridge according to claim 1, wherein the interfered part is formed with a tapering surface formed at a tip end of the swing cover.

4. The lead cartridge according to claim 1, wherein at least a part of the swing cover is arranged in the tank part.

5. The lead cartridge according to claim 4, wherein a protrusion that closes the lead port is formed on the swing cover and a protruding end of the protrusion is in a tapering shape.

6. The lead cartridge according to claim 1, further comprising a stick article advancing mechanism that advances a stick article through a rotating operation at a rear part of the lead cartridge.

7. The lead cartridge according to claim 1, wherein the swing cover is swingable by a lead held by the lead feeding mechanism in the mechanical pencil.

8. A mechanical pencil into which the lead cartridge according to claim 1 is to be loaded, wherein the interference part is formed with a tapering surface capable of interfering with a tip end of the swing cover.

9. A lead cartridge that is provided with a tank part for storing leads and is capable of being detachably connected to a receiving part provided in a lead feeding mechanism of a mechanical pencil to supply a lead, the lead cartridge comprising:
a tip end connection part that can be detachably fitted with the receiving part;
a lead port provided on a tip end side of the tank part to allow a lead to pass therethrough from the tank part; and
a swing cover that is arranged swingably to a closing position where the swing cover closes the lead port and to an opening position where the swing cover opens the lead port at a position posterior to the lead port, wherein
the swing cover is biased in a swing direction from the opening position to the closing position, and prevents a lead in the tank part from aligning with the lead port in a condition closing the lead port.

10. The lead cartridge according to claim 2, wherein the interfered part is formed with a tapering surface formed at a tip end of the swing cover.

11. The lead cartridge according to claim 2, wherein at least a part of the swing cover is arranged in the tank part.

12. The lead cartridge according to claim 3, wherein at least a part of the swing cover is arranged in the tank part.

13. The lead cartridge according to claim 2, further comprising a stick article advancing mechanism that advances a stick article through a rotating operation at a rear part of the lead cartridge.

14. The lead cartridge according to claim 3, further comprising a stick article advancing mechanism that advances a stick article through a rotating operation at a rear part of the lead cartridge.

15. The lead cartridge according to claim 4, further comprising a stick article advancing mechanism that advances a stick article through a rotating operation at a rear part of the lead cartridge.

16. The lead cartridge according to claim 5, further comprising a stick article advancing mechanism that advances a stick article through a rotating operation at a rear part of the lead cartridge.

17. The lead cartridge according to claim 2, wherein the swing cover is swingable by a lead held by the lead feeding mechanism in the mechanical pencil.

18. The lead cartridge according to claim 3, wherein the swing cover is swingable by a lead held by the lead feeding mechanism in the mechanical pencil.

19. The lead cartridge according to claim 4, wherein the swing cover is swingable by a lead held by the lead feeding mechanism in the mechanical pencil.

20. The lead cartridge according to claim 5, wherein the swing cover is swingable by a lead held by the lead feeding mechanism in the mechanical pencil.
